(19) United States
(12) Patent Application Publication
(10) Pub. No.: US 2020/0099432 A1
(43) Pub. Date: Mar. 26, 2020

(54) Methods and Apparatus Relating to Channel State Information Reporting in a Wireless Communication Network

(71) Applicant: Telefonaktiebolaget LM Ericsson (publ), Stockholm (SE)

(72) Inventors: Helka-Liina Määttanen, Helsinki (FI); Icaro L. J. da Silva, Solna (SE)

(21) Appl. No.: 16/089,931

(22) PCT Filed: May 9, 2018
(86) PCT No.: PCT/SE2018/050485

§ 371 Date: Sep. 28, 2018

Related U.S. Application Data
(60) Provisional application No. 62/505,449, filed on May 12, 2017.

(51) Int. Cl. H04B 7/06; H04L 5/00; H04W 80/02; H04W 72/04

(52) U.S. Cl. CPC H04B 7/0626; H04L 5/0051; H04B 7/0632; H04B 7/0617; H04W 72/042; H04B 7/063; H04W 80/02

(57) ABSTRACT

The disclosure provides methods and apparatus relating to channel state information reporting in a wireless communication network. In one embodiment, there is provided a method in a base station for a wireless communication network. The wireless communication network serves a user equipment configured with a plurality of resources for the reception by the user equipment of a plurality of reference signals.

The method comprises: transmitting a configuration to the user equipment. The configuration comprises an indication of a first subset of the plurality of reference signals, for which the user equipment is configured to report a first type of channel state information feedback, and a second subset of the plurality of reference signals, for which the user equipment is configured to report a second type of channel state information feedback.

### TECHNICAL FIELD

Embodiments of the present disclosure relate to methods and apparatus in a wireless communication network, and particularly to methods and apparatus relating to channel state information reporting in a wireless communication network.

### BACKGROUND

In Long Term Evolution (LTE), until Release 13, all reference signals that the UE uses for channel state information (CSI) calculation (e.g. cell-specific reference signals, CRSs, and CSI reference signals, CSI-RS), were non-precoded such that the UE is able to measure the raw channel and calculate feedback including a preferred precoding matrix based on that. As the number of Tx antennas increases, the amount of feedback becomes larger. In Release-10, when support for 8Tx closed loop precoding was introduced, a double codebook approach was introduced where the UE first selects a wideband coarse precoder and then per subband a second codeword. Another possible approach is that the network node beamforms a reference signal and the UE calculates feedback on top of that. This approach was adopted in Rel-13, while a further option for FD-MIMO (full-dimension multiple-input-multiple-output, where the antenna system can form a beam along any horizontal or vertical direction) was also defined as described in the next section.

Rel-13 FD-MIMO specification in LTE supports an enhanced CSI-RS reporting called Class B for beamformed CSI-RS. Therein, an LTE RRC CONNECTED UE can be configured with K beams (where 8>K>1) where it can be 1, 2, 4 or 8 antenna ports for each beam. For CSI feedback purposes (i.e. precoding matrix indicator, PMI, rank indicator, RI and channel quality indicator, CQI there is a CSI-RS Resource Indicator per CSI-RS. The UE reports the CSI-RS index (CRI) to indicate the preferred beam where the CRI is wideband, RI/CQI/PMI is based on legacy codebook (i.e. Rel-12) and

CRI reporting period is an integer multiple of the RI. For Rel-14 eFD-MIMO (i.e. enhanced FD-MIMO), aperiodic CSI-RS was introduced with two different sub-flavors. The CRS-RS resources are configured for the UE as in Rel-13 and the set of K CSI-RS resources is configured to work as aperiodic, or semipersistent, The UE waits for media access control (MAC) control element (CE) activation for N out of K CSI-RS resources (where N≥K). For aperiodic CSI-RS, the UE waits for, in addition to the MAC CE, a downlink control information (DCI) activation of the CSI-RS resource before reporting. For semi-persistent CSI-RS, the UE considers the CSI-RS activated after receiving the MAC CE.

FIG. 1 shows the transmission of beamformed reference signals (e.g. CSI-RS) from a transmission point to a wireless terminal device. The transmission point may be a radio-access network node, such as an eNodeB or a gNodeB, or a remote radio head associated with such a radio-access network node.

The MAC CE activation/deactivation command is specified in TS36.321, version 14.2,1, where Section 5.19 describes:
The network may activate and deactivate the configured CSI-RS resources of a serving cell by sending the Activation/Deactivation of CSI-RS resources MAC control element described in subclause 6.1.3.14. The configured CSI-RS resources are initially deactivated upon configuration and after a handover.

And Section 6.1.3.14:
The Activation/Deactivation of CSI-RS resources MAC control element is identified by a MAC PDU subheader with LCID as specified in table 6.2.1-1. It has variable size as the number of configured CSI process (N) and is defined in FIG. 6.1.3.14-1. Activation/Deactivation CSI-RS command is defined in FIG. 6.1.3.14-2 and activates or deactivates CSI-RS resources for a CSI process. Activation/Deactivation of CSI-RS resources MAC control element applies to the serving cell on which the UE receives the Activation/Deactivation of CSI-RS resources MAC control element.
The Activation/Deactivation of CSI-RS resources MAC control elements is defined as follows:
   Rᵢ: this field indicates the activation/deactivation status of the CSI-RS resources associated with CSI-RS-ConfigNZPId i for the CSI-RS process. The Rᵢ field is set to “1” to indicate that CSI-RS resource associated with CSI-RS-ConfigNZPId i for the CSI-RS process shall be activated. The Rᵢ field is set to “0” to indicate that the CSI-RS-ConfigNZPId i shall be deactivated.

See also FIGS. 2 and 3, which correspond to FIG. 6.1.3.14-1 (showing Activation/Deactivation of CSI-RS resources MAC Control Element) and FIG. 6.1.3.14-2 (showing the Activation/Deactivation CSI-RS command) of TS36.321, version 14.2.1, respectively.

The MAC activation was introduced in LTE to be able to configure more CSI-RS resources for a UE than the UE is able to support feedback for as the MAC CE would selectively activate up to the maximum CSI-RS resources supported. Then, without the need to reconfigure by RRC, the network may activate another set among the resources configured for the UE.

Efforts are on-going to develop and standardize communications networks and protocols intended to meet the requirements set out for the fifth generation (5G) of wireless systems, as defined by the Next Generation Mobile Networks Alliance. In the new system (also known as “New Radio” or “NR”), all reference signals may be beamformed.

In NR, the synchronization sequences (NR-PSS/NR-SSS) and physical broadcast channel (PBCH) which includes demodulation reference signal (DMRS) constitutes a so-called SS Block. An RRC_CONNECTED UE trying to access a target cell should assume that the SS Block may be transmitted in the form of repetitive bursts of SS Block transmissions (denoted “SS Burst”), wherein such a burst consists of a number of SS Block transmissions following close after each other in time. Furthermore, a set of SS Bursts may be grouped together (denoted “SS Burst Set”), where the SS Bursts in the SS Burst Sets are assumed to have some relation to each other, Both SS Bursts and SS Burst Sets have their respective given periodicity. In the single beam scenarios, the network could configure time-repetition within one SS Burst in a wide beam. In multi-beam scenarios, at least some of these signals and physical channels (e.g. SS Block) would be transmitted in multiple beams, which could be done in different manners depending on network implementation, as shown in FIG. 1.

FIG. 4 shows different configurations of an SS Burst Set. Top: Time-repetition within one SS Burst in a wide beam. Middle: Beam-sweeping of a small number of beams using only one SS Burst in the SS Burst Set. Bottom: Beam-sweeping of a larger number of beams using more than one SS Burst in the SS Burst Set to form a complete sweep.

Which of these three alternatives to implement may be left as a network vendor choice. That choice depends on the tradeoff between i) the overhead caused by transmitting periodic and always on narrow beam sweepings vs. ii) the delays and signalling needed to configure the UE to find a narrow beam for the physical downlink shared channel (PDSCH) or the physical downlink control channel (PDCCH), The implementation shown in the upper figure prioritizes i), while the implementation shown in the bottom figure prioritizes ii), The figure in the middle case is an intermediate case, where a sweeping of wide beams is used. In that case the number of beams to cover the cell is reduced, but in some cases an additional refinement is needed for narrow gain beamforming of PDSCH,

It is likely that network vendors will provide cell coverage with a low number of beams for the IDLE mode coverage which could imply a fairly low number of SS Blocks per Burst Set. Hence, once the UE accesses a cell using a random-access procedure, either via state transition to CONNECTED or via handovers, further beam management procedures need to be configured and DL beams to be used for the transmission of PDCCH/PDSCH may need to be further refined.

For that purpose, RANI is defining in NR a CSI-RS framework, for the so called beam management and CSI acquisition procedures or transmission point (TRP) recognition in same cell ID scenarios. The same cell ID scenario is equivalent to one of the LTE CoMP scenarios where concept of (LTE) transmission point TP was introduced. A TP/TRP is basically a remote radio head (RRH) and all RRHs have same cell ID within one cell area. This means that they all send the same CRS (in LTE) or SSB (in NR) and therefore CSI-RS is the only means for the UE to separate a TP/TRP.
For NR, the following DL L1/L2 beam management procedures are supported within one or multiple TRPs:
P-1: is used to enable UE measurement on different TRP Tx beams to support selection of TRP Tx beams/UE Rx beam(s)
For beamforming at TRP, it typically includes a intra/inter-TRP Tx beam sweep from a set of different beams
For beamforming at UE, it typically includes a UE Rx beam sweep from a set of different beams
FFS: TAP Tx beam and UE Rx beam can be determined jointly or sequentially
is used to enable UE measurement on different TAP Tx beams to possibly change inter/intra-TRP Tx beam(s)
From a possibly smaller set of beams for beam refinement than in P-1
Note: P-2 can be a special case of P-1
P-3: is used to enable UE measurement on the same TAP Tx beam to change UE Rx beam in the case UE uses beamforming
Strive for the same procedure design for Intra-TRP and inter-TAP beam management
Note: UE may not know whether it is intra-TRP or inter TAP beam
Note: Procedures P-2&P-3 can be performed jointly and/or multiple times to achieve e.g. TAP Tx/UE Rx beam change simultaneously
Note: Procedures P-3 may or may not have physical layer procedure spec. impact
Support managing multiple Tx/Rx beam pairs for a UE
Note: Assistance information from another carrier can be studied in beam management procedures
Note that above procedure can be applied to any frequency band
Note that above procedure can be used in single/multiple beam(s) per TRP
Note: multi/single beam based initial access and mobility treated within a separate RAN1 agenda item

NR has also adopted the terminology of aperiodic and semi-persistent CSI-RS as well as aperiodic and semi-persistent CSI reporting that may happen from periodic, semipersistent or aperiodic CSI-RS with certain limitations.

One problem which may be addressed by the following concepts relates to feedback calculation from the configured CSI-RS, especially in cases where the UE reports CSI information for the configured CSI-RS (e.g. PMI, Al, CQI). In NA, as will be seen from the discussion above, the number of CSI-RS configurations which could be considered by the UE can become rather large. As UE processing capacity is limited, it is not always possible or desirable to report CSI for each CSI-RS configuration, At the same time, for beam management, CSI-RSRP may be considered. Further, the feedback overhead should be considered.

Given this, there is a need for efficient handling as to which CSI-RS resources the UE should consider for sending feedback, as well as which type of beam level feedback the UE should send.

### SUMMARY

To address these and other problems, the present disclosure provides methods and apparatus as described below.

In one aspect there is provided a method in a base station for a wireless communication network. The wireless communication network serves a user equipment configured with a plurality of resources for the reception by the user equipment of a plurality of reference signals. The method comprises: transmitting a configuration to the user equipment. The configuration comprises an indication of a first subset of the plurality of reference signals, for which the user equipment is configured to report a first type of channel state information feedback, and a second subset of the plurality of reference signals, for which the user equipment is configured to report a second type of channel state information feedback.

The disclosure further provides apparatus, such as a base station, configured to perform the method set out above.

For example, in one aspect the disclosure provides a base station for a wireless communication network. The wireless communication network serves a user equipment configured with a plurality of resources for the reception by the user equipment of a plurality of reference signals. The base station comprises processing circuitry and a machine-readable medium storing data which, when executed by the processing circuitry, causes the base station to: transmit a configuration to the user equipment. The configuration comprises an indication of a first subset of the plurality of reference signals, for which the user equipment is configured to report a first type of channel state information feedback, and a second subset of the plurality of reference signals, for which the user equipment is configured to report a second type of channel state information feedback.

In a further aspect, the disclosure provides a method in a user equipment for a wireless communication network. The user equipment is configured with a plurality of resources for the reception of a plurality of reference signals. The method comprises: receiving a configuration from a base station for the wireless communication network. The configuration comprises an indication of a first subset of the plurality of reference signals, for which the user equipment is configured to report a first type of channel state information feedback, and a second subset of the plurality of reference signals, for which the user equipment is configured to report a second type of channel state information feedback.

The disclosure further provides apparatus, such as a user equipment, configured to perform the method set out above.

For example, in one aspect the disclosure provides a user equipment for a wireless communication network. The user equipment is configured with a plurality of resources for the reception of a plurality of reference signals. The user equipment comprises processing circuitry and a non-transitory machine-readable medium storing instructions which, when executed by the processing circuitry, cause the user equipment to: receive a configuration from a base station for the wireless communication network. The configuration comprises an indication of a first subset of the plurality of reference signals, for which the user equipment is configured to report a first type of channel state information feedback, and a second subset of the plurality of reference signals, for which the user equipment is configured to report a second type of channel state information feedback.

For example, the UE may be configured with M CSI-RS resources and it can potentially report CSI from N of those resources and the simpler CSI-RSRP from K of those resources. The CSI-RS resource and/or the feedback may be configured in an aperiodic manner such that a MAC CE is used to signal which feedback—CSI or CSI-RSRP, for example—the UE should report for which resource configuration.

By such a method, the network may be able to decide whether it wants to configure the UE to measure and report more granular beam level information (such as PMI, RI, COI per sub-band and/or other CSI-related information) or less granular beam level information (such as RSRP, RSRQ or SINR) depending on factors such as:
UE capability for deriving CSI feedback and CSI-RSRP for multiple CSI-RS configurations;
Availability of UL resources;
UE mobility pattern (where more stable UEs could afford refinement of the reporting mechanism, while that could be more complicated for mobile UEs where beam tracking can be complex);
Service requirements in terms of beam refinement.

Note that the discussion below focuses on a technical solution for LTE and those networks intended to meet the requirements set out for the fifth generation (5G) of wireless systems, as defined by the Next Generation Mobile Networks Alliance. However, those skilled in the art will appreciate that it is also possible to apply the methods and apparatus described herein to other networks and access technologies. In other networks, nodes and interfaces may have different names.

### BRIEF DESCRIPTION OF THE DRAWINGS

For a better understanding of the present disclosure, and to show how it may be put into effect, reference will now be made, by way of example, to the accompanying drawings, in which:

FIG. 1 illustrates the transmission of beamformed reference signals from a transmission point to a wireless terminal device;

FIG. 2 corresponds to FIG. 6.1.3.14-1 of the 3GPP technical standards document 36.321, version 14.2.1;

FIG. 3 corresponds to FIG. 6.1.3.14-2 of the 3GPP technical standards document 36.321, version 14.2.1;

FIG. 4 illustrates the transmission of synchronization sequences according to different configurations;

FIG. 5 shows a network according to embodiments of the disclosure;

FIG. 6 is a flow chart of a method in a network node according to embodiments of the disclosure;

FIG. 7 illustrates a configuration message according to embodiments of the disclosure;

FIG. 8 is a flow chart of a method in a wireless terminal device according to embodiments of the disclosure;

FIG. 9 is a schematic diagram of a network node according to embodiments of the disclosure;

FIG. 10 is a schematic diagram of a network node according to further embodiments of the disclosure;

FIG. 11 is a schematic diagram of a wireless terminal device according to embodiments of the disclosure;

FIG. 12 is a schematic diagram of a wireless terminal device according to further embodiments of the disclosure;

FIG. 13 is a flow chart of a method in a network node according to embodiments of the disclosure; and

FIG. 14 is a flow chart of a method in a wireless terminal device according to embodiments of the disclosure.

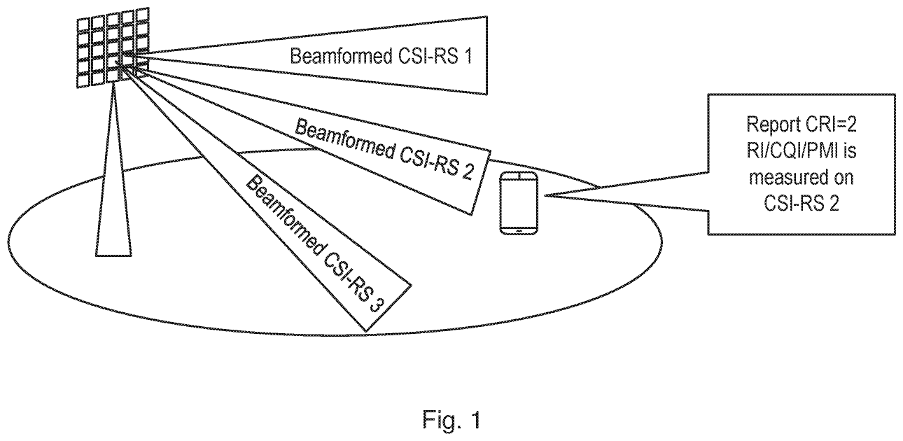

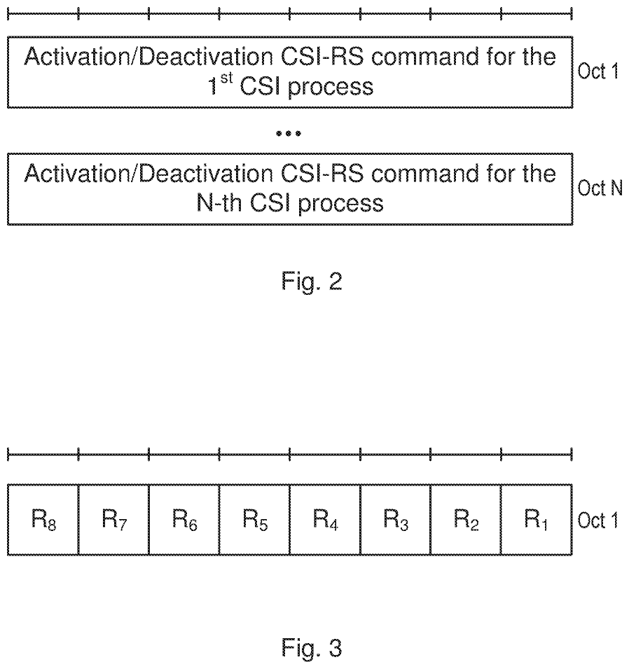

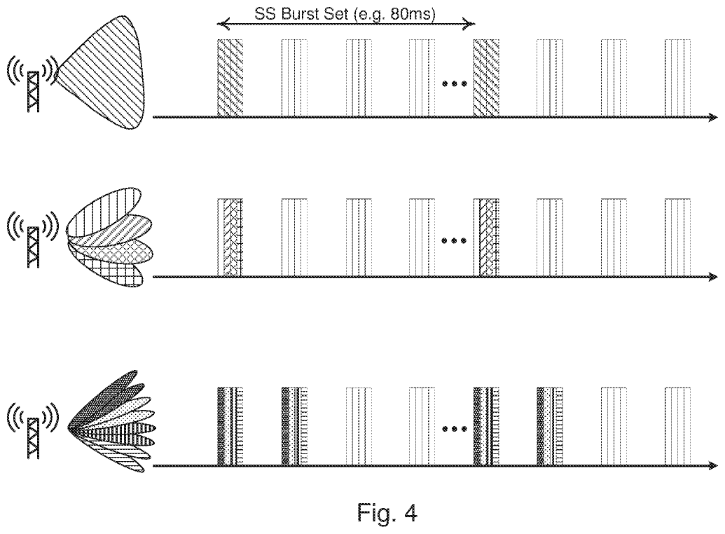

### DETAILED DESCRIPTION

The following sets forth specific details, such as particular embodiments for purposes of explanation and not limitation. But it will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Although the description is given for a wireless terminal device, or user equipment (UE), it should be understood by the skilled in the art that “UE” is a non-limiting term comprising any mobile or wireless device, terminal or node equipped with a radio interface allowing for at least one of: transmitting signals in uplink (UL) and receiving and/or measuring signals in downlink (DL). A UE herein may comprise a UE (in its general sense) capable of operating or at least performing measurements in one or more frequencies, carrier frequencies, component carriers or frequency bands. It may be a “UE” operating in single- or multi-radio access technology (RAT) or multi-standard mode. As well as “UE”, the terms “mobile station” (“MS”), “mobile device”, “terminal device” and “wireless terminal device” may be used interchangeably in the following description, and it will be appreciated that such a device does not necessarily have to be ‘mobile’ in the sense that it is carried by a user. Examples of UE are target device, device to device (D2D) UE, machine type UE or UE capable of machine to machine (M2M) communication, PDA, tablet computer, mobile terminals, smart phone, laptop embedded equipped (LEE), laptop mounted equipment (LME), USB dongles, ProSe UE, V2V UE, V2X UE, MTC UE, eMTC UE, FeMTC UE, UE Cat 0, UE Cat M narrowband Internet of Things (NB-IoT) UE, UE Cat NB1, etc.

In some embodiments a more general term “network node” is used and it can correspond to any type of radio access node or any network node, which communicates with a UE and/or with another network node. Examples of network nodes are NodeB, MeNB, SeNB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, SON, positioning node (e.g. E-SMLC), MDT, test equipment, etc. Moreover, where the following description refers to steps taken in or by a network node or a radio access node, this also includes the possibility that some or all of the processing and/or decision making steps may be performed in a device that is physically separate from the radio antenna of the node, but is logically connected thereto. Thus, where processing and/or decision making is carried out “in the cloud”, the relevant processing device is considered to be part of the node for these purposes.

The embodiments are described for LTE or LTE based systems such as machine-type communication (MTC), evolved MTC (eMTC), NB-IoT etc. As an example MTC UE, eMTC UE and NB-IoT UE also called UE category 0, UE category M1 and UE category NB1. However, the embodiments are applicable to any RAT or multi-RAT systems, where the UE receives and/or transmit signals (e.g. data) e.g. LTE FDD/TDD, WCDMA/HSPA, GSM/GERAN, Wi-Fi, WLAN, CDMA2000, 5G, NR, etc. It is recalled that 5G, the fifth generation of mobile telecommunications and wireless technology is not yet fully defined but in an advanced draft stage within 3GPP. It includes work on 5G New Radio (NR) Access Technology. LTE terminology is used in this disclosure in a forward looking sense, to include equivalent 5G entities or functionalities although a different term is specified in 5G. A general description of the agreements on 5G New Radio (NR) Access Technology so far is contained in most recent versions of the 3GPP 38-series Technical Reports.

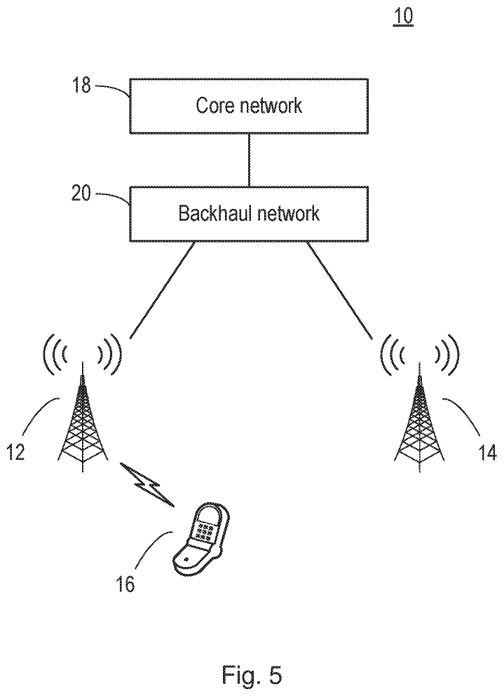

FIG. 5 illustrates a network 10 that may be utilized to explain the principles of embodiments of the present disclosure. The network 10 comprises network nodes 12, 14 which are connected, via a backhaul network 20, to a core network 18. FIG. 5 also shows a terminal device (or UE, wireless terminal, etc) 16 that is in wireless communication with the network node 12. Messages transmitted by the terminal device 16 to the network node 12 are said to be transmitted in the “uplink”, while messages transmitted by the network node 12 to the terminal device 16 are said to be transmitted in the “downlink”. The network nodes 12, 14 may transmit signals via a respective pluralities of beams. One or more of the beams may be relatively wide, and extend from the network node in substantially all directions. Conversely, one or more of the beams may be relatively narrow (e.g. through the use of beam-forming techniques), and extend from the network node in a particular direction. The plurality of beams may comprise multiple such narrow beams, configured to extend from the network node in different directions. The network nodes 12, 14 may transmit reference signals, such as CSI-RS, which differ between different beams, such that a beam can be identified based on the reference signal.

Although the terminal device 16 is illustrated as a mobile phone, or smartphone, it will be understood by those skilled in the art that the terminal device may be any device that is configured for communication with the wireless communication network 10.

The network node 12 may be of a type referred to as e.g. radio access nodes, base stations, NodeBs, evolved NodeBs (eNB, or eNodeB), gNodeBs, base transceiver stations, Access Point Base Stations, base station routers, Radio Base Stations (RBSs), macro base stations, micro base stations, pico base stations, femto base stations, Home eNodeBs, relays and/or repeaters, transmission points, beacon devices or any other network node configured for communication with wireless devices over a wireless interface, depending e.g. on the radio access technology and terminology used.

Thus the wireless terminal 16 may be configured with a plurality of resources (i.e. one or more of frequency, time slots, or orthogonal codes) for receiving respective reference signals (e.g. CSI-RS). The reference signals may be transmitted by the same network node, or by different network nodes. The reference signals may be transmitted via the same beam, or different beams. The wireless terminal 16 may be configured with the plurality of resources via signalling from one or more of the network nodes 12, 14, For example, radio resource configuration (RRC) signalling may convey an indication of the resources on which the wireless terminal 16 should listen for the reference signals.

According to embodiments of the disclosure, the wireless terminal is further configured with an indication of at least a first subset of the plurality of reference signals and a second subset of the plurality of reference signals. The first and second subset may each comprise one or more of the plurality of reference signals. For the first subset, the wireless terminal 16 is configured to report a first type of channel state information feedback (or a first set of channel state information feedback); for the second subset, the wireless terminal 16 is configured to report a second type of channel state information feedback (or a second set of channel state information feedback). The first type of CSI feedback may comprise more granular beam level information than the second type of CSI feedback. For example, the first type of CSI feedback may comprise one or more of; a precoding matrix indicator; a rank indicator; and a channel quality indicator. The second type of CSI feedback may comprise one or more of: a reference signal received power (RSRP); a reference signal received quality (RSRQ); a signal to noise ratio; and a signal to interference and noise ratio. The second type of CSI feedback may comprise less data than the first type of CSI feedback.

Thus the wireless terminal 16 can be configured to measure and report detailed CSI feedback information for a first subset of the reference signals, and limited CSI feedback information for a second subset of the reference signals. The configuration of the first and second subsets may take into account a number of different factors, as explained below. For example, the configuration may take into account one or more of: the wireless terminal capabilities, the availability of uplink resources, the mobility of the wireless terminal, and the quality of service requirements for communications associated with the wireless terminal. In this way, resources in the wireless terminal 16 can be utilized appropriately, given the circumstances of the wireless terminal 16 and the network which serves it.

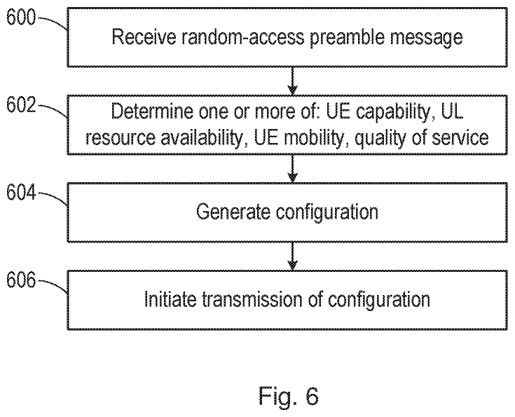

FIG. 6 is a flow chart of a method in a network node according to embodiments of the disclosure. For example, the method may be carried out in a radio access network node, such as the nodes 12, 14 illustrated in FIG. 5. Alternatively, the method may be carried out in a node which is coupled to a radio-access network node, and is operative to receive data from wireless signals received by the radio-access network node, and to control the radio-access network node to transmit wireless signals. For example, such a node may be embodied in a cloud computing environment.

In some embodiments, the method is performed as part of a random-access procedure. Such a random-access procedure may occur when a wireless terminal first accesses the network, when the wireless terminal switches from an inactive state (such as RRC_IDLE or RRC_INACTIVE) to an active state (such as RRC_CONNECTED), or when the wireless terminal executes handover from one network node to another (e.g. from node 12 to node 14 illustrated in FIG. 5). In the latter case, the method may be carried out in the target node of the handover process (i.e. the node to which the wireless terminal is handed over).

Thus, in step 600, the network node receives a random-access preamble message from the wireless terminal. The random-access preamble message may be received over a random-access channel, such as the physical random-access channel (PRACH), or any other channel suitable for the transmission and reception of random-access preamble messages.

In step 602, the network node determines one or more characteristics of the wireless terminal and/or the network node. For example, in one embodiment the network node determines one or more of: the capability of the wireless terminal for deriving CSI feedback for multiple reference signal configurations; the availability of radio resources (e.g. one or more of frequency, time slots and orthogonal codes) for uplink transmissions from the wireless terminal to the network node; the mobility of the wireless terminal; and a quality of service associated with communications from or to the wireless terminal. In some embodiments, the network node determines all of these parameters. In other embodiments the network node determines only a subset of the parameters, such as one parameter or more than one parameter (in any combination of the parameters listed above). The network node may also determine additional parameters to those listed above.

The capability of the wireless terminal may relate to the capability of the wireless terminal to receive multiple reference signals and derive first, detailed channel state information feedback (e.g. such as a preceding matrix indicator; a rank indicator; and a channel quality indicator) or second, less detailed channel state information feedback (e.g. such as a received signal received power; a received signal received quality; a signal to noise ratio; and a signal to interference and noise ratio). For example, the capability may comprise values N and K for the maximum numbers of reference signals on which the first and second CSI feedback can be derived, respectively. The numbers may be determined or set by a manufacturer of the wireless terminal, based on the processing power of the wireless terminal, the number of antennas, etc. The capability may be transmitted to the network upon initiation of a connection (i.e. upon initiation of an RRC connection), and stored in a database which is accessible by the network nodes of the network.

The availability of UL resources for communications between the wireless terminal and the network node may be determined based on the proportion of total resources which are available for UL transmissions by the wireless terminal (i.e. which are not scheduled for transmissions by other wireless terminals). The proportion may be calculated over a finite future time period. Such information may be available at the network node (particularly if the network node is responsible for scheduling), or accessible by the network node. The availability may also depend on network operator policies concerning the amount of resources which should be provided to a wireless terminal for reporting of channel state information.

The mobility of the wireless terminal may be determined based on mobility reports that are available to the network node for the wireless terminal. Such mobility reports may be reported by the wireless terminal and stored in a database which is accessible by the network node, or generated by a node of the network (e.g. based on previous handover requests, previous channel state information reports, etc) and stored in such a database.

The quality of service requirements may be determined by determining the quality of service of radio bearers that the wireless terminal is configured with. This information is available to the network node.

The wireless terminal may be configured with a plurality of resources (i.e. one or more of frequency, time slots, and orthogonal codes) for receiving respective reference signals (e.g. CSI-RS). The reference signals may be transmitted by the same network node, or by different network nodes. The reference signals may be transmitted via the same beam, or different beams. The wireless terminal may be configured with the plurality of resources via signalling from one or more network nodes. For example, radio resource configuration (RRC) signalling may convey an indication of the resources on which the wireless terminal should listen for the reference signals.

In step 604, the network node determines an appropriate channel state information reporting configuration and generates a configuration comprising an indication of that channel state information reporting configuration. The indication may comprise an indication of a first subset of the reference signals which the wireless terminal is configured with, and an indication of a second subset of the reference signals which the wireless terminal is configured with. The wireless terminal is configured to report a first type of channel state information feedback for the first subset of reference signals, and a second type of channel state information feedback for the second subset of reference signals. The first type of CSI feedback may comprise more granular beam level information than the second type of CSI feedback. For example, the first type of CSI feedback may comprise one or more of: a precoding matrix indicator; a rank indicator; and a channel quality indicator. The second type of CSI feedback may comprise one or more of: a received signal received power; a received signal received quality; a signal to noise ratio; and a signal to interference and noise ratio. The second type of CSI feedback may comprise less data than the first type of CSI feedback.

The network node may select the appropriate channel state information reporting configuration from a plurality of possible channel state information reporting configurations. For example, the plurality of possible channel state information reporting configurations may comprise a list of the plurality of reference signals with which the wireless terminal is configured (or the resources over which those reference signals are transmitted). Such a plurality of possible configurations may be provided to the network node by another network node, for example, in a handover command message when the method is carried out as part of a handover process. Alternatively, the network node may be pre-coded with the plurality of possible configurations, or provided with the plurality of possible configurations from a core network node. In still further embodiments, the network node may determine the numbers of reference signals in the first and second subsets, and then randomly select reference signals for allocation to the first and second subsets. Those skilled in the art will appreciate that many alternatives are possible without departing from the scope of the concepts disclosed herein and defined in the numbered paragraphs and claims below.

The network node may determine the appropriate channel state information reporting configuration based on one or more of the parameters determined in step 602. For example, the network node may ensure that the first and second subsets do not comprise more than the numbers N and K which indicate the wireless terminal's capability to report channel state information.

In a further example, the network node may determine the appropriate channel state information reporting configuration as a function of the available resources for uplink messages, by which function the first subset has a greater number of reference signals, and the second subset has a lesser number of reference signals, for greater availability of radio resources for uplink messages. Alternatively or additionally, the network node may determine the appropriate channel state information reporting configuration as a function of the available resources for uplink messages, by which function the channel state information reporting does not exceed the available resources for UL messages.

In a further example, the network node may determine the appropriate channel state information reporting configuration as a function of the determined mobility of the wireless terminal device, by which function the first subset has a lesser number of reference signals, and the second subset has a greater number of reference signals, for greater mobility of the mobility of the wireless terminal. That is, as the wireless terminal is more mobile, the wireless terminal is configured to report CSI feedback of the first type for a lesser number of reference signals; conversely, the wireless terminal may be configured to report CSI feedback of the second type for a greater number of reference signals. Wireless terminals which are less mobile, or stationary, may benefit from more stable radio conditions and so be able to report CSI feedback for a greater number of reference signals (particularly of the first type).

Further still, the network node may determine the appropriate channel state information reporting configuration as a function of the determined quality of service, by which function the first subset has a greater number of reference signals, and the second subset has a lesser number of reference signals, for higher quality of service of communications to or from the wireless terminal (e.g. radio bearers associated with the wireless terminal).

Note that any and all of these parameters may be combined such that a function which takes as an input more than one of the parameters listed above outputs a suitable channel state information reporting configuration.

The configuration itself may take various forms. For example, the configuration may comprise a media access control (MAC) control element (CE), or downlink control information. The configuration may form part of a random-access response message, i.e. an initial response to the random-access preamble message received in step 600. In such embodiments, the configuration is aperiodic.

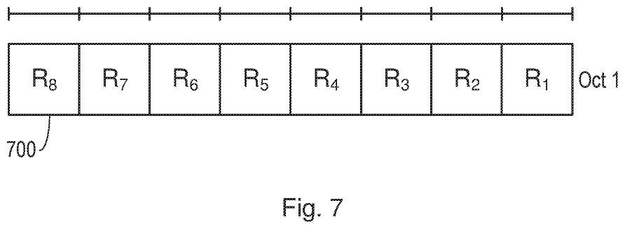

Further detail concerning the configuration is provided below with respect to FIG. 7.

In step 606, transmission of the configuration is initiated. That is, where the method is carried out in the radio-access network node, the network node transmits the configuration itself; where the method is carried out in a node coupled to the radio-access network node, the network node transmits a control message to the radio-access network node to transmit the configuration.

FIG. 7 illustrates a configuration message 700 according to embodiments of the disclosure.

In the illustrated embodiment, the configuration message 700 comprises a bitmap containing a respective bit or group or bits for each of the plurality of reference signals the wireless terminal is configured with. In the illustrated embodiment, the bitmap comprises 8 bits and is an octet; in other embodiments, more or fewer bits may be provided (for example, the message 700 may comprise multiple octets).

Let the number of reference signals (e.g. the resources for CSI-RS) configured for the wireless terminal be denoted M, and the maximum capabilities of the wireless terminal for CSI feedback reporting of the first type and the second type be N and K, respectively, as before. If K=M, or K+N=M, the bitmap can be defined by having each bit in the octet correspond to one reference signal configuration, i.e. there are no spare bits of the bitmap, as the wireless terminal is capable of reporting CSI information according to at least one of the first or second type for each of the configured reference signals. In such embodiments, each bit may comprise an indication of whether the wireless terminal should report CSI feedback of the first type or the second type. For example, when a bit takes a first value (e.g. “1”), the wireless terminal may be configured to report CSI feedback according to the first type for the corresponding reference signal. When the bit takes a second value (e.g. “0”), the wireless terminal may be configured to report CSI feedback according to the second type for the corresponding reference signal.

If K<M−N, the wireless terminal is not capable of reporting CSI feedback information for all of the configured reference signals. In that case, a group of bits may be defined for each of the configured reference signals. For example, when a group of bits takes a first value (e.g. “00”), the corresponding reference signal resource may not be activated, such that the wireless terminal should not consider the reference signal or report any CSI feedback information for it. When the group of bits takes a second value (e.g. “10”), the wireless terminal may be configured to report CSI feedback according to the first type for the corresponding reference signal. When the group of bits takes a third value (e.g. “01”), the wireless terminal may be configured to report CSI feedback according to the second type for the corresponding reference signal. In such embodiments, the fourth value (e.g. “11”) may be reserved, or indicate to the wireless terminal that the corresponding reference signal was transmitted, but that the wireless terminal may not use the reference signal for CSI feedback reporting. For example, the wireless terminal may use the transmitted reference signal for some other purpose, such as an update of CSI-RSRP measurement, averaging for CSI-RSRP, or enhancement for channel estimator needed for CSI reporting or for any other channel parameter tracking.

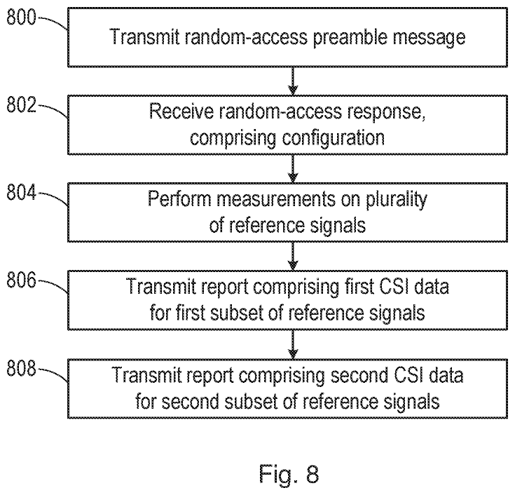

FIG. 8 is a flow chart of a method in a wireless terminal device according to embodiments of the disclosure. For example, the wireless terminal device may be the wireless terminal 16 described above with respect to FIG. 5.

The wireless terminal may be configured with a plurality of resources (i.e. one or more of frequency, time slots, and orthogonal codes) for receiving respective reference signals (e.g. CSI-RS). The reference signals may be transmitted by the same network node, or by different network nodes. The reference signals may be transmitted via the same beam, or different beams. The wireless terminal may be configured with the plurality of resources via signalling from one or more network nodes. For example, radio resource configuration (RRC) signalling may convey an indication of the resources on which the wireless terminal should listen for the reference signals.

In some embodiments, the method is performed as part of a random-access procedure. Such a random-access procedure may occur when a wireless terminal first accesses the network, when the wireless terminal switches from an inactive state (such as RRC_IDLE or RRC_INACTIVE) to an active state (such as ARC_CONNECTED), or when the wireless terminal executes handover from one network node to another (e.g. from node 12 to node 14 illustrated in FIG. 5).

Thus, in step 800, the wireless terminal device transmits a random-access preamble message to a network node for the wireless communications network. The random-access preamble message may be transmitted over a random-access channel, such as the physical random-access channel (PRACH), or any other channel suitable for the transmission of random-access preamble messages.

In step 802, the wireless terminal receives a configuration from the network node. In embodiments where the method is performed as part of a random-access procedure, the configuration may form part of a random-access response message.

The configuration comprises an indication of an appropriate channel state information reporting configuration for the wireless terminal device. The indication may comprise an indication of a first subset of the plurality of reference signals which the wireless terminal is configured with, and an indication of a second subset of the reference signals which the wireless terminal is configured with. The wireless terminal is configured to report a first type of channel state information feedback for the first subset of reference signals, and a second type of channel state information feedback for the second subset of reference signals. The first type of CSI feedback may comprise more granular beam level information than the second type of CSI feedback. For example, the first type of CSI feedback may comprise one or more of: a precoding matrix indicator; a rank indicator; and a channel quality indicator. The second type of CSI feedback may comprise one or more of: a received signal received power; a received signal received quality; a signal to noise ratio; and a signal to interference and noise ratio. The second type of CSI feedback may comprise less data than the first type of CSI feedback.

Further detail concerning the configuration may be found above with respect to FIGS. 6 and 7.

In step 804, the wireless terminal performs measurements on at least the first and second subsets of reference signals. In some embodiments, the wireless terminal may perform measurements on all of the plurality of reference signals which the wireless terminal is configured with, regardless of whether the reference signals are indicated as belonging to the first or second subsets.

In step 806, the wireless terminal derives and transmits CSI reporting information to the network node for the first subset of reference signals. The CSI reporting information may belong to a first type of CSI feedback data.

In step 808, the wireless terminal derives and transmits CSI reporting information to the network node for the second subset of reference signals. The CSI reporting information may belong to a second type of CSI feedback data.

The first type of CSI feedback may comprise more granular beam level information than the second type of CSI feedback. For example, the first type of CSI feedback may comprise one or more of; a preceding matrix indicator; a rank indicator; and a channel quality indicator, The second type of CSI feedback may comprise one or more of: a received signal received power; a received signal received quality; a signal to noise ratio; and a signal to interference and noise ratio. The second type of CSI feedback may comprise less data than the first type of CSI feedback.

Steps 806 and 808 may be carried out in parallel, and transmitted in the same message or in different messages.

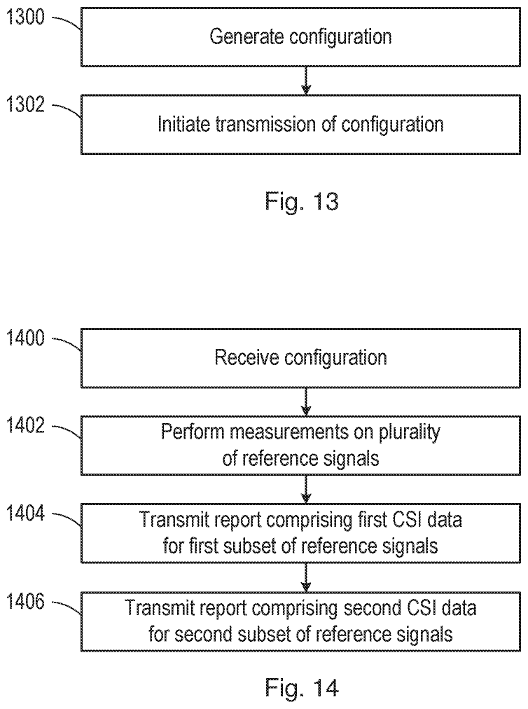

FIG. 13 is a flow chart of a method in a network node according to embodiments of the disclosure. For example, the method may be carried out in a radio access network node, such as the nodes 12, 14 illustrated in FIG. 5. Alternatively, the method may be carried out in a node which is coupled to a radio-access network node, and is operative to receive data from wireless signals received by the radio-access network node, and to control the radio-access network node to transmit wireless signals. For example, such a node may be embodied in a cloud computing environment.

In step 1300, the network node determines an appropriate channel state information reporting configuration and generates a configuration comprising an indication of that channel state information reporting configuration. The indication may comprise an indication of a first subset of the reference signals which the wireless terminal is configured with, and an indication of a second subset of the reference signals which the wireless terminal is configured with. The wireless terminal is configured to report a first type of channel state information feedback for the first subset of reference signals, and a second type of channel state information feedback for the second subset of reference signals. The first type of CSI feedback may comprise more granular beam level information than the second type of CSI feedback. For example, the first type of CSI feedback may comprise one or more of: a precoding matrix indicator; a rank indicator; and a channel quality indicator. The second type of CSI feedback may comprise one or more of: a received signal received power; a received signal received quality; a signal to noise ratio; and a signal to interference and noise ratio. The second type of CSI feedback may comprise less data than the first type of CSI feedback.

The network node may select the appropriate channel state information reporting configuration from a plurality of possible channel state information reporting configurations. For example, the plurality of possible channel state information reporting configurations may comprise a list of the plurality of reference signals with which the wireless terminal is configured (or the resources over which those reference signals are transmitted). Such a plurality of possible configurations may be provided to the network node by another network node, for example, in a handover command message when the method is carried out as part of a handover process. Alternatively, the network node may be pre-coded with the plurality of possible configurations, or provided with the plurality of possible configurations from a core network node. In still further embodiments, the network node may determine the numbers of reference signals in the first and second subsets, and then randomly select reference signals for allocation to the first and second subsets. Those skilled in the art will appreciate that many alternatives are possible without departing from the scope of the concepts disclosed herein and defined in the numbered paragraphs and claims below.

The configuration itself may take various forms. For example, the configuration may comprise a media access control (MAC) control element (CE), or downlink control information. The configuration may form part of a random-access response message, i.e. an initial response to a random-access preamble message. In such embodiments, the configuration is aperiodic.

Further detail concerning the configuration is provided above with respect to FIG. 7.

In step 1302, transmission of the configuration is initiated. That is, where the method is carried out in the radio-access network node, the network node transmits the configuration itself; where the method is carried out in a node coupled to the radio-access network node, the network node transmits a control message to the radio-access network node to transmit the configuration.

FIG. 14 is a flow chart of a method in a wireless terminal device according to embodiments of the disclosure. For example, the wireless terminal device may be the wireless terminal 16 described above with respect to FIG. 5.

The wireless terminal may be configured with a plurality of resources (i.e. one or more of frequency, time slots, and orthogonal codes) for receiving respective reference signals (e.g. CSI-RS). The reference signals may be transmitted by the same network node, or by different network nodes. The reference signals may be transmitted via the same beam, or different beams. The wireless terminal may be configured with the plurality of resources via signalling from one or more network nodes. For example, radio resource configuration (ARC) signalling may convey an indication of the resources on which the wireless terminal should listen for the reference signals.

In step 1400, the wireless terminal receives a configuration from the network node. In embodiments where the method is performed as part of a random-access procedure, the configuration may form part of a random-access response message.

The configuration comprises an indication of an appropriate channel state information reporting configuration for the wireless terminal device. The indication may comprise an indication of a first subset of the plurality of reference signals which the wireless terminal is configured with, and an indication of a second subset of the reference signals which the wireless terminal is configured with. The wireless terminal is configured to report a first type of channel state information feedback for the first subset of reference signals, and a second type of channel state information feedback for the second subset of reference signals. The first type of CSI feedback may comprise more granular beam level information than the second type of CSI feedback. For example, the first type of CSI feedback may comprise one or more of: a precoding matrix indicator; a rank indicator; and a channel quality indicator. The second type of CSI feedback may comprise one or more of: a received signal received power; a received signal received quality; a signal to noise ratio; and a signal to interference and noise ratio. The second type of CSI feedback may comprise less data than the first type of CSI feedback.

Further detail concerning the configuration may be found above with respect to FIG. 7.

In step 1402, the wireless terminal performs measurements on at least the first and second subsets of reference signals. In some embodiments, the wireless terminal may perform measurements on all of the plurality of reference signals which the wireless terminal is configured with, regardless of whether the reference signals are indicated as belonging to the first or second subsets.

In step 1404, the wireless terminal derives and transmits CSI reporting information to the network node for the first subset of reference signals. The CSI reporting information may belong to a first type of CSI feedback data.

In step 1406, the wireless terminal derives and transmits CSI reporting information to the network node for the second subset of reference signals. The CSI reporting information may belong to a second type of CSI feedback data.

The first type of CSI feedback may comprise more granular beam level information than the second type of CSI feedback. For example, the first type of CSI feedback may comprise one or more of; a precoding matrix indicator; a rank indicator; and a channel quality indicator. The second type of CSI feedback may comprise one or more of: a received signal received power; a received signal received quality; a signal to noise ratio; and a signal to interference and noise ratio. The second type of CSI feedback may comprise less data than the first type of CSI feedback.

Steps 1404 and 1406 may be carried out in parallel, and transmitted in the same message or in different messages.

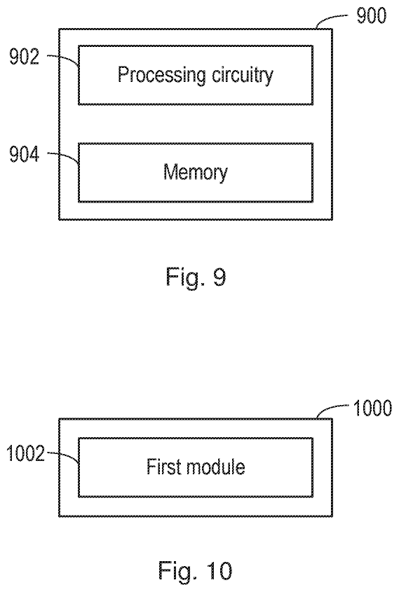

FIG. 9 is a schematic diagram of a network node 900 according to embodiments of the disclosure. The network node 900 may be suitable to perform the method shown in and described with respect to FIG. 6, for example. The network node 900 may correspond to a radio access network node, such as the network node 12 or 14 described above with respect to FIG. 5, or may correspond to a node which is connected to and controls such a radio access network node.

The network node 900 may be suitable for a wireless communications network, the network serving a terminal device which is configured with a plurality of resources for the reception of a corresponding plurality of reference signals.

The network node 900 comprises processing circuitry 902 and a non-transitory machine-readable medium 904 (such as memory) which is coupled to the processing circuitry 902. The machine-readable medium 904 comprises instructions which, when executed by the processing circuitry 902, cause the network node to: transmit a configuration to the wireless terminal device, the configuration comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

The network node 900 may also generally comprise interface circuitry (i.e. hardware and/or software) for transmitting and receiving signals, such as one or more antennas, and transceiver circuitry coupled to the one or more antennas for transmitting and receiving wireless signals, or optical and/or electrical circuitry for transmitting and receiving optical or electrical signals.

FIG. 10 is a schematic diagram of a network node 1000 according to further embodiments of the disclosure. The network node 1000 may be considered as an alternative description of the network node 900 described above. The network node 1000 may be suitable to perform the method shown in and described with respect to FIG. 6, for example. The network node 1000 may correspond to a radio access network node, such as the network node 12 or 14 described above with respect to FIG. 5, or may correspond to a node which is connected to and controls such a radio access network node.

The network node 1000 may be suitable for a wireless communications network, the network serving a terminal device which is configured with a plurality of resources for the reception of a corresponding plurality of reference signals.

The network node 1000 comprises a first module 1002 configured to: transmit a configuration to the wireless terminal device, the configuration comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

The network node 1000 may also generally comprise one or more interface modules for transmitting and receiving signals, such as one or more antennas, and transceiver modules coupled to the one or more antennas for transmitting and receiving wireless signals, or optical and/or electrical modules for transmitting and receiving optical or electrical signals.

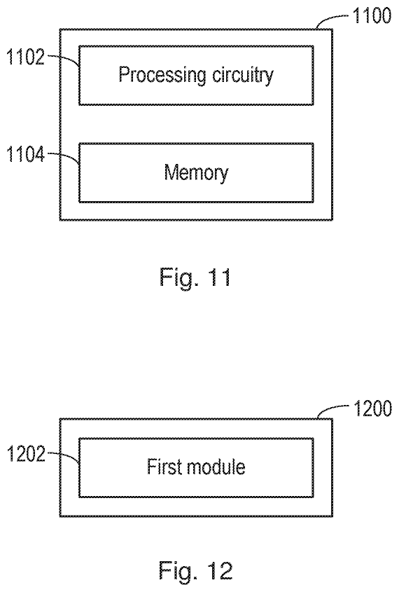

FIG. 11 is a schematic diagram of a terminal device 1100 according to embodiments of the disclosure. For example, the terminal device 1100 may correspond to the terminal device 16 described above. The terminal device 1100 may be suitable for performing the method described above with respect to FIG. 8.

The terminal device may be configured with a plurality of resources for the reception of a corresponding plurality of reference signals.

The terminal device 1100 comprises processing circuitry 1102 and a non-transitory machine-readable medium 1104 storing instructions which, when executed by the processing circuitry 1102, cause the terminal device to: receive a configuration from a network node for the wireless communication network, the configuration comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

The terminal device 1100 may also generally comprise hardware and/or software for transmitting and receiving wireless signals, such as one or more antennas, and transceiver circuitry coupled to the one or more antennas.

FIG. 12 is a schematic diagram of a terminal device 1200 according to further embodiments of the disclosure. The terminal device 1200 may be considered as an alternative description of the terminal device 1100 described above. For example, the terminal device 1200 may correspond to the terminal device 16 described above. The terminal device 1200 may be suitable for performing the method described above with respect to FIG. 8.

The terminal device may be configured with a plurality of resources for the reception of a corresponding plurality of reference signals.

The terminal device 1200 comprises a first module 1202, a second module 804 and a third module 806. The first module 802 is configured to receive a configuration from a network node for the wireless communication network, the configuration comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

The terminal device 1200 may also generally comprise hardware and/or modules for transmitting and receiving wireless signals, such as one or more antennas, and transceiver modules coupled to the one or more antennas.

Thus the disclosure provides methods and apparatus for the configuration of channel state information feedback reporting. A wireless terminal can be configured to measure and report detailed CSI feedback information for a first subset of the reference signals, and limited CSI feedback information for a second subset of the reference signals. The configuration of the first and second subsets may take into account a number of different factors, as explained below. For example, the configuration may take into account one or more of: the wireless terminal capabilities, the availability of uplink resources, the mobility of the wireless terminal, and the quality of service requirements for communications associated with the wireless terminal. In this way, resources in the wireless terminal can be utilized appropriately, given the circumstances of the wireless terminal and the network which serves it.

It should be noted that the above-mentioned embodiments illustrate rather than limit the concepts disclosed herein, and that those skilled in the art will be able to design many alternative embodiments without departing from the scope of the appended following statements. The word “comprising” does not exclude the presence of elements or steps other than those listed in a statement, “a” or “an” does not exclude a plurality, and a single processor or other unit may fulfil the functions of several units recited in the statements. Any reference signs in the statements shall not be construed so as to limit their scope.

The following number statements set out embodiments of the disclosure:

1. A method in a network node for a wireless communication network, the wireless communication network serving a wireless terminal device configured with a plurality of resources for the reception by the wireless terminal device of a corresponding plurality of reference signals, the method comprising:
transmitting a configuration message to the wireless terminal device, the configuration message comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

2. The method according to paragraph 1, wherein the configuration message comprises a bitrnap containing respective bits or groups of bits for each of the plurality of reference signals, each respective bit or group of bits indicating whether the corresponding reference signal belongs to the first subset or the second subset.

3. The method according to paragraph 1 or 2, wherein the configuration message further comprises an indication of a third subset of the plurality of reference signals on which the wireless terminal device is not configured to report channel state information feedback.

4. The method according to paragraph 3 when dependent on paragraph 2, wherein the respective bits or groups of bits further indicate whether the corresponding reference signal belongs to the third subset.

5. The method according to any one of the preceding paragraphs, wherein the first type of channel state information feedback comprises more data than the second type of channel state information feedback.

6. The method according to any one of the preceding paragraphs, wherein the first type of channel state information feedback comprises one or more of: a preceding matrix indicator; a rank indicator; and a channel quality indicator.

7. The method according to any one of the preceding paragraphs, wherein the second type of channel state information comprises one or more of: a received signal received power; a received signal received quality; a signal to noise ratio; and a signal to interference and noise ratio.

8. The method according to any one of the preceding paragraphs, wherein the reference signals are channel state information reference signals.

9. The method according to any one of the preceding paragraphs, wherein the reference signals are transmitted by the network node.

10. The method according to any one of the preceding paragraphs, wherein the configuration message comprises a media access control, MAC, control element; or a downlink control information, DCI, message.

11. The method according to any one of the preceding paragraphs, wherein the configuration message is transmitted as part of a random-access procedure involving the wireless terminal device.

12. The method according to paragraph 11, wherein the configuration message is transmitted responsive to receipt of a random-access preamble from the wireless terminal device.

13. The method according to any one of the preceding paragraphs, wherein the network node is a target node for a handover procedure involving the wireless terminal device.

14. The method according to any one of the preceding paragraphs, further comprising:
determining a capability of the wireless terminal device to derive channel state information feedback for multiple reference signals; and
generating the configuration message based on the determined capability of the wireless terminal device.

15. The method according to any one of the preceding paragraphs, further comprising:
determining an availability of radio resources for uplink messages from the wireless terminal device to the network node; and
generating the configuration message based on the determined availability of radio resources for uplink messages.

16. The method according to paragraph 15, wherein the step of generating the configuration message comprises generating the configuration message as a function of the determined availability of radio resources for uplink messages, by which function the first subset has a greater number of reference signals, and the second subset has a lesser number of reference signals, for greater availability of radio resources for uplink messages.

17. The method according to any one of the preceding paragraphs, further comprising:
determining a mobility of the wireless terminal device; and
generating the configuration message based on the determined mobility of the wireless terminal device.

18. The method according to paragraph 17, wherein the step of generating the configuration message comprises generating the configuration message as a function of the determined mobility of the wireless terminal device, by which function the first subset has a lesser number of reference signals, and the second subset has a greater number of reference signals, for greater mobility of the mobility of the wireless terminal device.

19. The method according to any one of the preceding paragraphs, further comprising:
determining a quality of service associated with communications to or from the wireless terminal device; and
generating the configuration message based on the determined quality of service.

20. The method according to paragraph 19, wherein the step of generating the configuration message comprises generating the configuration message as a function of the determined quality of service, by which function the first subset has a greater number of reference signals, and the second subset has a lesser number of reference signals, for higher quality of service of communications to or from the wireless terminal device.

21. The method according to any one of the preceding paragraphs, wherein the plurality of reference signals are aperiodic.

22. A method in a wireless terminal device for a wireless communication network, the wireless terminal device being configured with a plurality of resources for the reception of a corresponding plurality of reference signals, the method comprising:
receiving a configuration message from a network node for the wireless communication network, the configuration message comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

23. The method according to paragraph 22, wherein the configuration message comprises a bitmap containing respective bits or groups of bits for each of the plurality of reference signals, each respective bit or group of bits indicating whether the corresponding reference signal belongs to the first subset or the second subset.

24. The method according to paragraph 22 or 23, wherein the configuration message further comprises an indication of a third subset of the plurality of reference signals on which the wireless terminal device is not configured to report channel state information feedback.

25. The method according to paragraph 24 when dependent on paragraph 23, wherein the respective bits or groups of bits further indicate whether the corresponding reference signal belongs to the third subset.

26. The method according to any one of paragraphs 22 to 25, wherein the first type of channel state information feedback comprises more data than the second type of channel state information feedback.

27. The method according to any one of paragraphs 22 to 26, wherein the first type of channel state information feedback comprises one or more of: a precoding matrix indicator; a rank indicator; and a channel quality indicator.

28. The method according to any one of paragraphs 22 to 27, wherein the second type of channel state information comprises one or more of: a received signal received power; a received signal received quality; a signal to noise ratio; and a signal to interference and noise ratio.

29. The method according to any one of paragraphs 22 to 28, wherein the reference signals are channel state information reference signals.

30. The method according to any one paragraphs 22 to 29, wherein the reference signals are transmitted by the network node.

31. The method according to any one of paragraphs 22 to 30, wherein the configuration message comprises a media access control, MAC, control element; or a downlink control information, DCI, message.

32. The method according to any one of paragraphs 22 to 31, wherein the configuration message is transmitted as part of a random-access procedure involving the wireless terminal device.

33. The method according to paragraph 32, further comprising transmitting a random access preamble message, wherein the configuration message is received within a response to the random-access preamble message.

34. The method according to any one of paragraphs 22 to 33, wherein the network node is a target node for a handover procedure involving the wireless terminal device.

35. The method according to any one of paragraphs 22 to 34, further comprising:
providing, to a node of the wireless communications network, a capability of the wireless terminal device to derive channel state information feedback for multiple reference signals,
wherein the indication of the first and second subsets is based on the provided capability of the wireless terminal device.

36. The method according to any one of paragraphs 22 to 35, wherein the indication of the first and second subsets is based on an availability of radio resources for uplink messages.

37. The method according to any one of paragraphs 22 to 36, further comprising:
providing, to a node of the wireless communications network, an indication of a mobility of the wireless terminal device,
wherein the indication of the first and second subsets is based on the mobility of the wireless terminal device.

38. The method according to any one of paragraphs 22 to 37, wherein the indication of the first and second subsets is based on a quality of service associated with communications to or from the wireless terminal device.

39. The method according to any one of paragraphs 22 to 38, wherein the plurality of reference signals are aperiodic.

40. The method according to any one of paragraphs 22 to 39, further comprising:
performing measurements on the first subset of reference signals; and
transmitting a report message comprising the first type of channel state information for the first subset of reference signals.

41. The method according to any one of paragraphs 22 to 40, further comprising:
performing measurements on the second subset of reference signals; and
transmitting a report message comprising the second type of channel state information for the second subset of reference signals.

42. A network node for a wireless communication network, the network node being configured to perform the method according to any one of paragraphs 1 to 21.

43. A network node for a wireless communication network, the wireless communication network serving a wireless terminal device configured with a plurality of resources for the reception by the wireless terminal device of a corresponding plurality of reference signals, the network node comprising processing circuitry and a machine-readable medium storing data which, when executed by the processing circuitry, causes the network node to:
transmit a configuration message to the wireless terminal device, the configuration message comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

44. The network node according to paragraph 43, wherein the network node is further configured to perform the method according to any one of paragraphs 2 to 21.

45. A network node for a wireless communication network, the wireless communication network serving a wireless terminal device configured with a plurality of resources for the reception by the wireless terminal device of a corresponding plurality of reference signals, the network node comprising:
a first module configured to transmit a configuration message to the wireless terminal device, the configuration message comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

46. A wireless terminal device for a wireless communication network, the wireless terminal device being configured to perform the method according to any one of paragraphs 22 to 41.

47. A wireless terminal device for a wireless communication network, the wireless terminal device being configured with a plurality of resources for the reception of a corresponding plurality of reference signals, the wireless terminal device comprising processing circuitry and a non-transitory machine-readable medium storing instructions which, when executed by the processing circuitry, cause the wireless terminal device to:
receive a configuration message from a network node for the wireless communication network, the configuration message comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

48. The wireless terminal device according to paragraph 47, further configured to perform the method according to any one of paragraphs 23 to 41.

49. A wireless terminal device for a wireless communication network, the wireless terminal device being configured with a plurality of resources for the reception of a corresponding plurality of reference signals, the wireless terminal device comprising:
a first module configured to receive a configuration message from a network node for the wireless communication network, the configuration message comprising an indication of a first subset of the plurality of reference signals, for which the wireless terminal device is configured to report a first type of channel state information feedback, and a second subset of the plurality of reference signals, for which the wireless terminal device is configured to report a second type of channel state information feedback.

1-34. (canceled)

35. A method in a base station for a wireless communication network, the wireless communication network serving a user equipment configured with a plurality of resources for the reception by the user equipment of a plurality of reference signals, the method comprising:
transmitting a configuration to the user equipment, the configuration comprising an indication of a first subset of the plurality of reference signals, for which the user equipment is configured to report a first type of channel state information feedback, and a second subset of the plurality of reference signals, for which the user equipment is configured to report a second type of channel state information feedback.

36. A method in a user equipment for a wireless communication network, the user equipment being configured with a plurality of resources for the reception of a plurality of reference signals, the method comprising:
receiving a configuration from a base station for the wireless communication network, the configuration comprising an indication of a first subset of the plurality of reference signals, for which the user equipment is configured to report a first type of channel state information feedback, and a second subset of the plurality of reference signals, for which the user equipment is configured to report a second type of channel state information feedback.

37. A base station configured to operate in a wireless communication network that is configured to serve a user equipment, the base station comprising:
transceiver circuitry configured for communication with the user equipment; and
processing circuitry operatively associated with the transceiver circuitry and configured to:
transmit a configuration to the user equipment, the configuration comprising an indication of a first subset of a plurality of reference signals, for which the user equipment is configured to report a first type of channel state information feedback, and a second subset of the plurality of reference signals, for which the user equipment is configured to report a second type of channel state information feedback.

38. The base station according to claim 37, wherein the configuration comprises a bitmap containing respective bits or groups of bits for each of the plurality of reference signals, each respective bit or group of bits indicating whether the corresponding reference signal belongs to the first subset or the second subset.

39. The base station according to claim 37, wherein the configuration further comprises an indication of a third subset of the plurality of reference signals on which the user equipment is not configured to report channel state information feedback.

40. The base station according to claim 37, wherein the first type of channel state information feedback comprises one or more of: a precoding matrix indicator; a rank indicator; and a channel quality indicator.

41. The base station according to claim 37, wherein the second type of channel state information comprises one or more of: a received signal received power; a received signal received quality; a signal to noise ratio; and a signal to interference and noise ratio.

42. The base station according to claim 37, wherein the configuration comprises a media access control (MAC) control element; or a downlink control information (DCI) message.

43. The base station according to claim 37, wherein the processing circuitry is configured to:
determine one or more of:
a capability of the user equipment to derive channel state information feedback for multiple reference signals;
an availability of radio resources for uplink messages from the user equipment to the base station;
a mobility of the user equipment; and
a quality of service associated with communications to or from the user equipment; and
generate the configuration based on the one or more determined capability, availability, mobility and quality of service.

44. A user equipment configured to operate in a wireless communication network, the user equipment comprising:
transceiver circuitry configured for communication with a base station of the wireless communication network; and
processing circuitry operatively associated with the transceiver circuitry and configured to:
receive a configuration from the base station, the configuration comprising an indication of a first subset of a plurality of reference signals, for which the user equipment is configured to report a first type of channel state information feedback, and a second subset of the plurality of reference signals, for which the user equipment is configured to report a second type of channel state information feedback.

45. The user equipment according to claim 44, wherein the configuration comprises a bitmap containing respective bits or groups of bits for each of the plurality of reference signals, each respective bit or group of bits indicating whether the corresponding reference signal belongs to the first subset or the second subset.

46. The user equipment according to claim 44, wherein the configuration further comprises an indication of a third subset of the plurality of reference signals on which the user equipment is not configured to report channel state information feedback.

47. The user equipment according to claim 44, wherein the first type of channel state information feedback comprises one or more of: a precoding matrix indicator; a rank indicator; and a channel quality indicator.

48. The user equipment according to claim 44, wherein the second type of channel state information comprises one or more of: a received signal received power; a received signal received quality; a signal to noise ratio; and a signal to interference and noise ratio.

49. The user equipment according to claim 44, wherein the configuration comprises a media access control (MAC) control element; or a downlink control information (DCI) message.

50. The user equipment according to claim 44, wherein the processing circuitry is configured to:
provide, to a node of the wireless communications network, a capability of the user equipment to derive channel state information feedback for multiple reference signals,
wherein the indication of the first and second subsets is based on the provided capability of the user equipment.

51. The user equipment according to claim 44, wherein the indication of the first and second subsets is based on an availability of radio resources for uplink message transmission by the user equipment.

52. The user equipment according to claim 44, wherein the indication of the first and second subsets is based on a quality of service associated with communications to or from the user equipment.
